(19) United States
(12) Patent Application Publication
(10) Pub. No.: US 2026/0340165 A1
(43) Pub. Date: Oct. 29, 2026

(54) DATA ACCESS SYSTEM, SERVER APPARATUS, DATA ACCESS METHOD AND PROGRAM

(71) Applicant: NIPPON TELEGRAPH AND TELEPHONE CORPORATION, Tokyo (JP)

(72) Inventor: Atsunori ICHIKAWA, Tokyo (JP)

(73) Assignee: NIPPON TELEGRAPH AND TELEPHONE CORPORATION, Tokyo (JP)

(21) Appl. No.: 19/117,737

(22) PCT Filed: Oct. 7, 2022
(86) PCT No.: PCT/JP2022/037720

§ 371 Date: Apr. 2, 2025

(51) Int. Cl. G06F 21/62

(52) U.S. Cl. CPC G06F 21/6218

(57) ABSTRACT

A server device includes: a transmission unit that transmits, to a client device, first data of any of N pieces of data stored in a first array in an initial state, and transmits, to the client device, all of second data stored in a second array capable of storing m pieces of data, m being less than N; a moving unit that deletes, from the first array, the first data transmitted to the client device by the transmission unit, and stores the first data in the second array; and a re-storage unit that re-stores data stored in the second array in the first array when the number of pieces of the second data stored in the second array is m or more, and the client device includes a selection unit that probabilistically selects any data from among the first data and pieces of the second data received from the server device. Accordingly, the present invention improves the spatial efficiency for keeping the contents regarding access to data secret from the server.

### TECHNICAL FIELD

The present invention relates to a data access system, a server device, a data access method, and a program.

### BACKGROUND ART

An ORAM (Oblivious RAM (Random Access Machine)) is a technique that enables a client to safely deposit data to an external server and access the data as needed. According to the ORAM, not only the data can be retrieved and referred simply while being encrypted, but also the retrieval history and the deviation (access pattern) of the retrieval can be concealed from the server, so that high safety can be realized. Some derivation techniques exist in the ORAM, and for example, derivation called simple ORAM is a kind of ORAM having excellent spatial efficiency. Specifically, when the original data set consists of B-bit data by N (total NB bits), while an ordinary ORAM requires a memory area having NB (1+η(1)) bits on the server side, NB (1+o(1)) bits is sufficient for the simple ORAM.

Another derivative is a technique called a RORAM (Random-Index ORAM) (NPL 1). The ordinary ORAM and the simple ORAM are defined as a function for acquiring desired data by explicitly specifying data to be accessed by a client (for example, a retrieval key or the like uniquely associated with the data is used for inputting a protocol) in data access. The RORAM, on the other hand, is defined such that the client does not specify data in the case of data access but instead, acquires random data (one or a plurality of pieces of data) from the data held by the server. In view of this property, the RORAM is difficult to use like an encrypted database, but instead, the RORAM is a technique that is expected to be utilized for safe random sampling and large-scale multi-party calculation for large-scale data.

### CITATION LIST

### Non Patent Literature

[NPL 1] Halevi, S. and Kushilevitz, E.: Random-Index Oblivious RAM, Cryptology ePrint Archive (2022).

### SUMMARY OF INVENTION

### Technical Problem

Since the RORAM does not require such requirement as “search for correct data from a search key” in the ordinary ORAM, many processes required in the ORAM can be omitted. Therefore, it is expected that the time efficiency and spatial efficiency can be reduced more than those of the ORAM, but in actuality, there is a current situation in which the reduction remains very little.

The present invention has been made in view of the points described above, and an object thereof is to improve the spatial efficiency for keeping the contents regarding access to data secret from the server.

### Solution to Problem

In order to solve the above problem, according to the present invention, a server device includes: a transmission unit configured to transmit, to a client device, first data of any of N pieces of data stored in a first array in an initial state, and transmit, to the client device, all of second data stored in a second array capable of storing m pieces of data, m being less than N; a moving unit configured to delete, from the first array, the first data transmitted to the client device by the transmission unit, and store the first data in the second array; and a re-storage unit configured to re-store data stored in the second array in the first array when the number of pieces of the second data stored in the second array is m or more, and the client device includes a selection unit configured to probabilistically select any data from among the first data and pieces of the second data received from the server device.

### Advantageous Effects of Invention

It is possible to improve the spatial efficiency for keeping the contents regarding access to data secret from the server.

### BRIEF DESCRIPTION OF DRAWINGS

FIG. 1 is a diagram showing a configuration example of a data access system according to an embodiment of the present invention.

FIG. 2 is a diagram showing an example of a hardware configuration of a server device 10 according to an embodiment of the present invention.

FIG. 3 is a diagram showing an example of a functional configuration of the server device 10 and a client device 20 according to an embodiment of the present invention.

FIG. 4 is a sequence diagram for explaining an example of a processing procedure of data access processing executed by the server device 10 and the client device 20.

### DESCRIPTION OF EMBODIMENTS

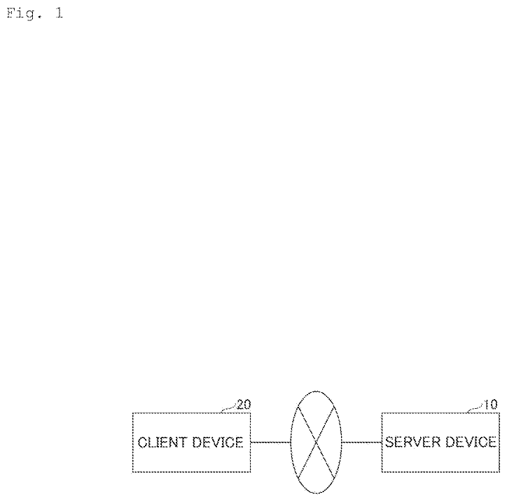

Hereinafter, embodiments of the present invention will be described with reference to the drawings. FIG. 1 is a diagram showing a configuration example of a data access system according to an embodiment of the present invention. In FIG. 1, the data access system includes a server device 10 and a client device 20. The server device 10 and the client device 20 are connected to each other via a network such as a LAN (Local Area Network) or the Internet.

The server device 10 is one or more computers that manage data.

The client device 20 is a computer for accessing data.

A plurality of server devices 10 may be present, or a plurality of client devices 20 may be present.

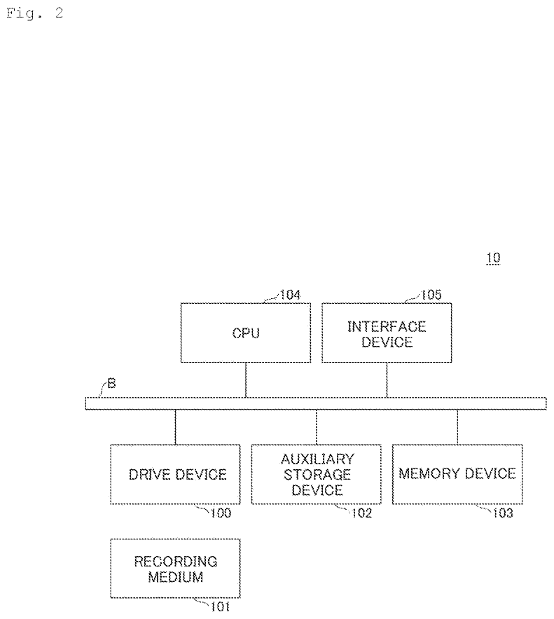

FIG. 2 is a diagram showing an example of a hardware configuration of the server device 10 according to an embodiment of the present invention. The server device 10 shown in FIG. 2 includes a drive device 100, an auxiliary storage device 102, a memory device 103, a CPU 104, and an interface device 105, which are connected with each other via a bus B.

A program for realizing processing in the server device 10 is provided by a recording medium 101 such as a CD-ROM. When the recording medium 101 with the program stored therein is set in the drive device 100, the program is installed from the recording medium 101 to the auxiliary storage device 102 via the drive device 100. However, the program does not necessarily have to be installed from the recording medium 101 and may be downloaded from another computer via a network. The auxiliary storage device 102 stores the installed program as well as necessary files, data, and the like.

The memory device 103 reads and stores the program from the auxiliary storage device 102 when an instruction for starting the program is issued. The CPU 104 executes the functions pertaining to the server device 10 in accordance with the program stored in the memory device 103. The interface device 105 is used as an interface to connect to the network.

Note that the client device 20 also has the hardware configuration shown in FIG. 2.

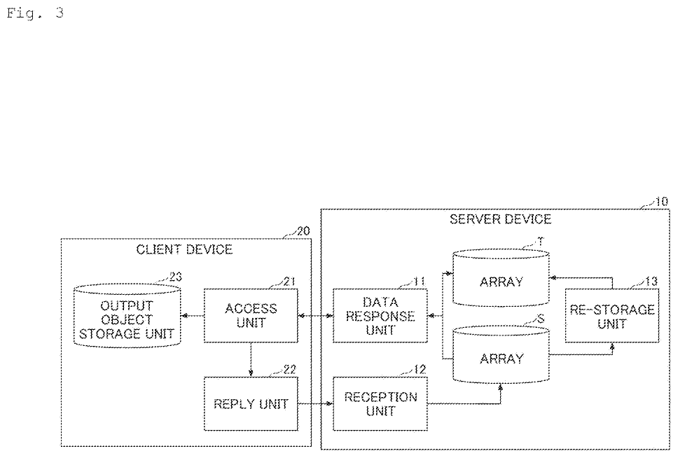

FIG. 3 is a diagram showing an example of a functional configuration of the server device 10 and the client device 20 according to the present embodiment. In FIG. 3, the server device 10 has a data response unit 11, a reception unit 12, and a re-storage unit 13. These respective units are implemented through processing that one or more programs installed on the server device 10 causes the CPU 104 to execute. The server device 10 also uses storage units such as an array T and an array S. These respective storage units can be implemented by using, for example, the auxiliary storage device 102, a storage device that can be connected to the server device 10 via the network, or the like.

On the other hand, the client device 20 has an access unit 21 and a reply unit 22. These respective units are implemented through processing that one or more programs installed on the client device 20 causes the CPU of the client device 20 to execute. The client device 20 also uses an output object storage unit 23. The output object storage unit 23 can be implemented by using, for example, a memory device or auxiliary storage device of the client device 20, or a storage device which can be connected to the client device 20 via the network.

The array T is an array having a capacity capable of storing each of all pieces of data held by the server device 10 as an element. In the present embodiment, it is assumed that the total number of all pieces of data is N. The capacity of the array T is N. In the initial state, all pieces of data (N pieces of data) are stored in the array T.

The array S is an array having a capacity of any integer m (<N). That is, the array S can store m pieces of data, which is less than N pieces of data. The array S is empty in the initial state.

Among the data stored in the array T, the data transmitted to the client device 20 is moved to the array S. When the array S is full, all data in the array S (m pieces data) are integrated with the remaining data ((N−m) pieces of data) in the array T and re-stored in the array T.

In the initialization, all N pieces of data are stored in the array T in a state where said N pieces of data are randomly replaced (shuffled). At this time, it is assumed that the server device 10 does not have the order of data arrangement, that is, replacement information used for the shuffling. Examples of a method for realizing this include a secret shuffle protocol (reference [4]) between the client device 20 and the server device 10, but any other methods may be adopted as long as they have the same properties. For example, a simple method may be used in which the client device 20 takes out all N pieces of data, shuffles and re-encrypt said N pieces of data, and returns the result to the server device 10. The literature information of each reference will be described later.

Hereinafter, a processing procedure (protocol) to be executed by the server device 10 and the client device 20 when accessing data will be described. Although omitted for the sake of simplicity, hereinafter, it is assumed that all data on the server device 10 are encrypted by a secret key of the client device 20, and that an encrypted text associated with re-encryption is re-randomized every time the client device 20 acquires and returns the data. The same processing may be performed as multi-party calculation by three or more server devices 10 instead of the two-party protocol between the client device 20 and the server device 10.

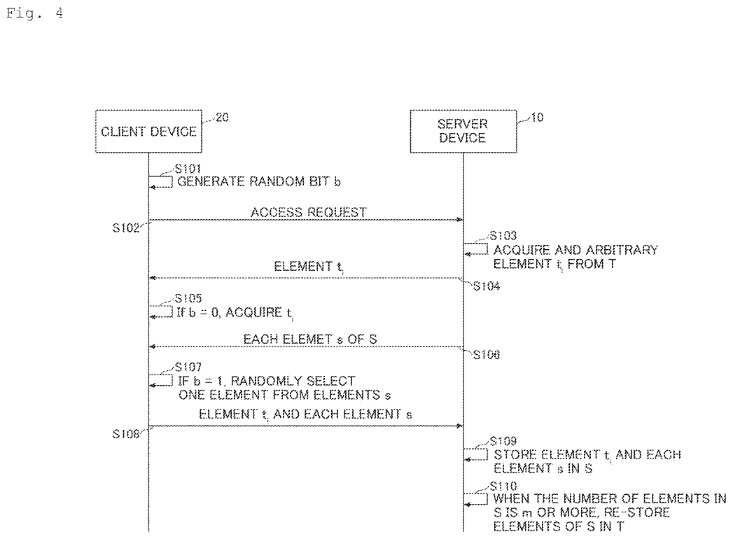

FIG. 4 is a sequence diagram for explaining an example of a processing procedure of data access processing executed by the server device 10 and the client device 20. It is assumed that, at the start of the processing procedure shown in FIG. 4, the number of pieces of data transferred to the array S is t (≤m).

In accessing data, the access unit 21 of the client device 20 generates a random bit b∈{0, 1} with a probability Pr[b=1]=arbitrary probability p(0≤p≤1) (S101). In this case, the probability that b becomes 1 is p. Note that when imparting a uniform output probability to all the data, the client device 20 may generate the random bit b with the probability Pr[b=1]=t/N. In this case, the probability that b becomes 1 is t/N. Note that step S101 is executed each time the data are accessed.

Subsequently, the access unit 21 transmits a data access request to the server device 10 (S102). Here, the data to be accessed are not designated. This is because the data to be accessed are random in the RORAM which is assumed in the present embodiment.

The data response unit 11 of the server device 10 extracts one arbitrary element tᵢ from the array T in response to the data access request, and deletes the tᵢ from the array T (S103). Then, the data response unit 11 transmits the tᵢ to the client device 20 (S104).

Upon receiving the tᵢ, the access unit 21 of the client device 20 saves the tᵢ in the output object storage unit 23 as an output for the access request, only when b is 0(S105). The output object storage unit 23 is a storage unit for storing data to be output (access objects), and has a capacity equivalent to one piece of data.

Subsequently, the data response unit 11 of the server device 10 transmits t elements s₁, . . . sₜ of the array S to the client device 20 and deletes these t elements from the array S (S106).

Upon receiving the elements s₁, . . . , sₜ, the access unit 21 of the client device 20 randomly selects one sⱼ from among the elements s₁, . . . , sₜ and saves the selected sⱼ in the output object storage unit 23 as an output for the access request, only when b is 1(S107). Further, the probability that each of the elements s₁, . . . , sₜ is selected is set to be a uniform distribution of 1/t, thereby achieving uniform random access to all data.

In this manner, based on b whose value is determined probabilistically, the output objects (access objects) are probabilistically selected from among the t₁ and s₁, . . . , sₜ.

Next, the reply unit 22 of the client device 20 returns all data (tᵢ and s₁, . . . sₜ) received from the server device 10 to the server device 10 (S108). Note that the client device 20 may rewrite or change arbitrary data among the returned data. The reply of the data may be executed collectively in step S108, or may be executed sequentially each time the data is received in steps S104 and S106.

Upon receiving the returned data, the reception unit 12 of the server device 10 stores all the received data in the array S (S109). In this case, the order of storing the data may be arbitrary. The movement of the tᵢ from the array T to the array S is realized by deleting the tᵢ from the array T by the data response unit 11 in step S103 and storing the tᵢ in the array S by the reception unit 12 in step S109. Further, the elements s₁, . . . , sₜ are to be re-stored in the array S.

In a case where the number of elements of the array S becomes m or more (i.e., in a case where the capacity of the array S is satisfied), the re-storage unit 13 integrates all the elements (m pieces of data) in the array S and all the elements ((N−m) pieces of data) in the array T to make N elements in total, replaces (shuffles) the order of the N elements randomly determines the order of the N elements), and then re-stores the N elements in the array T (S110). As for the shuffling, a method similar to the initialization may be used, or an oblivious intersperse algorithm disclosed in reference [5] may be used.

In the processing procedure described above, for convenience, an algorithm for accessing one piece of data by one access is illustrated as an example, but access to a plurality of pieces of data is also possible by changing the number of pieces of data transmitted/received in step S104 to an arbitrary number k which is equal to or less than m and setting the number of pieces of data selected in step S107 to k.

As described above, according to the present embodiment, the spatial efficiency of the data structure can be improved as compared with the conventional RORAMs and ORAMs, with respect to the RORAMs capable of random access to large-scale data. That is, it is possible to improve the spatial efficiency for keeping the contents regarding access to data secret from the Server.

Specifically, the existing RORAM (reference [1] ) requires a memory area NB (1+Θ(1)) similarly to a normal ORAM, whereas in the present embodiment, NB (1+o(1)) is sufficient, as with the simple ORAM (reference [2], [3]). In addition, the present embodiment has more excellent spatial efficiency while achieving the same calculation efficiency as compared with those of the existing simple ORAM (reference [3]). Specifically, reference [3] requires NB+√N (B+log N) bits, whereas in the present embodiment, only NB+√NB bits are required. Note that B is the number of bits of data, and N is the number of pieces of data.

Note that in the present embodiment, the array T is an example of the first array. The array S is an example of the second array. The element tᵢ is an example of the first data. Each of the elements s₁, . . . , sₜ is an example of the second data. The data response unit 11 is an example of the transmission unit. The data response unit 11 and the reception unit 12 are each an example of the moving unit. The access unit 21 is an example of the selection unit.

Although the embodiments of the present invention have been described in detail above, the present invention is not limited to such embodiments, and various modifications and changes are possible within the scope of the gist of the present invention described in the claims.

The literature information of the references described above are as follows.
[1] Goldreich, O. and Ostrovsky, R.: Software Protection and Simulation on Oblivious RAMs, J. ACM, Vol. 43, No. 3, pp. 431.473 (1996).
[2] Onodera, T. and Shibuya, T.: Succinct Oblivious RAM, STACS (2018).
[3] Riki Fukunari, Wakaha Ogata: Proposal of an extremely simple Oblivious RAM protocol, SCIS (2021).
[4] Patel, S., Persiano, G., and Yeo, K.: CacheShu.e: A family of oblivious shu.es, ICALP (2018)
[5] Asharov, G., Komargodski, I., Lin, W., Nayak, K., Peserico, E. and Shi, E.: OptORAMa: Optimal Oblivious RAM, EUROCRYPT, pp. 403.432(2020 )

### REFERENCE SIGNS LIST

10 Server device
11 Data response unit
12 Reception unit
13 Re-storage unit
20 Client device
21 Access unit
22 Reply unit
23 Output object storage unit
100 Drive device
101 Recording medium
102 Auxiliary storage device
103 Memory device
104 CPU
105 Interface device
B Bus

1. A data access system comprising a client device and a server device,
wherein the server device:
transmits, to the client device, first data of any of N pieces of data stored in a first array in an initial state, and transmits, to the client device, all of second data stored in a second array capable of storing m pieces of data, m being less than N;
deletes, from the first array, the first data transmitted to the client device by the transmission unit, and stores the first data in the second array; and
re-stores data stored in the second array in the first array when the number of pieces of the second data stored in the second array is m or more, and
the client device includes:
probabilistically selects any data from among the first data and pieces of the second data received from the server device.

2. The data access system according to claim 1, wherein an order of the data stored in the second array is randomly determined and the data stored in the first array when the number of pieces of the data stored in the second array is m or more, and the data is stored in the second array and the data stored in the first array in the first array.

3. The data access system according to claim 1, wherein the client device:
returns the first data and all of the second data to the server device, and
deletes the first data from the first array when the transmission unit transmits the first data, and to store the first data and all of the second data returned from the client device in the second array.

4. A server device, comprising:
transmitting, to a client device, first data of any of N pieces of data stored in a first array in an initial state, and transmit, to the client device, all of second data stored in a second array capable of storing m pieces of data, m being less than N;
deleting, from the first array, the first data transmitted to the client device by the transmission unit, and store the first data in the second array; and
re-storing data stored in the second array in the first array when the number of pieces of the second data stored in the second array is m or more.

5. A data access method for causing a computer to execute:
a transmission procedure of transmitting, to a client device, first data of any of N pieces of data stored in a first array in an initial state, and transmitting, to the client device, all of second data stored in a second array capable of storing m pieces of data, m being less than N;
a moving procedure of deleting, from the first array, the first data transmitted to the client device by the transmission procedure, and storing the first data in the second array; and
a re-storage procedure of re-storing data stored in the second array in the first array when the number of pieces of the second data stored in the second array is m or more.

6. A program for causing a computer to execute:
a transmission procedure of transmitting, to a client device, first data of any of N pieces of data stored in a first array in an initial state, and transmitting, to the client device, all of second data stored in a second array capable of storing m pieces of data, m being less than N;
a moving procedure of deleting, from the first array, the first data transmitted to the client device by the transmission procedure, and storing the first data in the second array; and
a re-storage procedure of re-storing data stored in the second array in the first array when the number of pieces of the second data stored in the second array is m or more.

7. The server device according to claim 4, further comprising the first array, wherein the first array stores all data held by the server device as elements, and the maximum capacity of the array t is equal to N.

8. The server device according to claim 7, wherein the data stored in the first array that is sent to a client device is moved to the second array.

9. The server device according to claim 7, wherein when the second array is filled, all data in the second array is integrated with remaining data in first array and re-stored in first array.

10. The server device according to claim 7, wherein upon initialization, all N pieces of data are randomly permuted and stored in the first array.

11. The data access system according to claim 1, wherein the client device generates a random bit having a probability Pr[b=1]=any probability p (0≤p≤1).

12. The data access system according to claim 1, wherein the client device requests to access a piece of data from the server device without specifying the piece of data to access.

13. The data access system according to claim 12, wherein the server device extracts an arbitrary element tᵢ from the first array and deletes tᵢ from the first array upon receiving the request to access the piece of data and transmits the data to the client device.

14. The data access system according to claim 13, wherein the client device outputs the arbitrary element tᵢ when b=0.

15. The data access system according to claim 14, wherein the client device randomly selects one element from an array of elements when b=1 and stores the selected element as an output.

16. The data access system according to claim 15, wherein the client device returns to the server device with all data received from the server device in which the client device rewrites or changes any of the data returned to the server data.

17. The data access system according to claim 16, wherein the server device stores all of the received data in the second array in any order.

18. The data access system according to claim 1, wherein number of elements in the first array becomes m or more, all elements in the first array is combined with the second array to generate a total of N elements, permutates an order of the N elements and re-stores the N elements in the first array.
